(19) United States
(12) Patent Application Publication
(10) Pub. No.: US 2002/0166036 A1
(43) Pub. Date: Nov. 7, 2002

(54) Multiple memory block disable function

(76) Inventor: Charles E. Watts JR., Crowley, TX (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/850,950

(22) Filed: May 7, 2001

(51) Int. Cl. G06F 12/00

(52) U.S. Cl. 711/163

(57) ABSTRACT

An apparatus and method of providing a multiple memory block disable function in a microcontroller system. The multiple memory block disable function allows a customer to protect its micro-code from being altered or copied. An exemplary apparatus includes a processor, a first memory block in communication with the processor, a second memory block in communication with the processor, and a disable circuit, operable to disable the first memory block following a first programming operation and disable the second memory block following a second programming operation.

### BACKGROUND OF THE INVENTION

Use of microprocessors is becoming increasingly common in a variety of applications. Indeed, in many ways they form the backbone of an electronic system. Engineers expend a great deal of effort, time and creativity into programming the software for the microcontrollers in these designs. Indeed, in many cases the creativity put into developing the software is central to the overall success of the design. Some existing designs provide a microcontroller the ability to protect programmed information by implementing a read and write disable feature. However, this feature locks up all portions of memory, so that all software must be programmed into the device's memories at a single site. This is not an adequate solution in some applications that, for example, may need to be programmed at more than one site.

For example, in some applications it is desirable to first program the main program into a ROM at a first site and then program application specific data (e.g. parameter data and serialization data) into an embedded EEPROM at a second site. Unfortunately, the single lock solution described above is unworkable for the following reasons. On the one hand, invoking the single lock (i.e. read and write disable) feature would prevent programming the EEPROM at the second site. Conversely, and on the other hand, not invoking the single lock feature in such circumstances would result in shipping the partially programmed part to the second site unlocked. This option is also undesirable, since it poses a risk that the main program may be copied.

### SUMMARY OF THE INVENTION

The present invention comprises an apparatus and method of providing a multiple memory block disable function, which allows a customer to protect its micro-code from being altered or copied.

In a first aspect of the invention a method of disabling multiple memory blocks in a microcontroller system comprises the steps of programming a first set of data into a first memory block, disabling read and write access to the programmed first memory block, programming a second set of data into a second memory block 2 and disabling read and write access to the second memory block. The first set of data may comprise software for directing operation of the system and/or the second set of data may comprise a password, which enables operation of the system. Additionally, the first memory block may comprise a non-volatile memory and/or the second memory block may comprise an erasable programmable read only memory (EPROM).

Here and throughout, the term “EPROM” is used in its most broad sense to include conventional EPROM's as well as other subsets of such a device (e.g. an electrically erasable PROM or EEPROM). Accordingly, when the term EPROM is used in this application, it will encompass all types of erasable PROMs, unless otherwise stated.

In a second aspect of the invention, a microcontroller system comprises a processor, a first memory block in communication with the processor, a second memory block in communication with the processor; and a register in communication with the first and second memory blocks. In this aspect of the invention, the register has two or more disable bits that control a read or write access to the first and second memory blocks. The first memory block may comprise a non-volatile memory and/or be configured to store software for directing operation of the system. The second memory block may comprise an EPROM and/or be configured to accept a customer password to enable operation of the system.

In a third aspect of the invention a microcontroller system comprises a processor, a first memory block in communication with the processor, a second memory block in communication with the processor, and a disable circuit, in communication with the processor, operable to disable the first memory block following a first programming operation and disable the second memory block following a second programming operation.

A further understanding of the nature and advantages of the inventions herein may be realized by reference to the remaining portions of the specification and the attached drawings.

### BRIEF DESCRIPTION OF THE DRAWINGS

FIG. 1 shows a microcontroller system that provides a multiple memory block disable function according to an embodiment of the present invention;

FIG. 2 shows an exemplary initialization register contained within the microcontroller system shown in FIG. 1, according to an embodiment of the present invention;

FIG. 3 shows a flow chart illustrating an exemplary method of programming multiple memory components of the system shown in FIG. 1, according to an embodiment of the present invention;

FIG. 4 shows an exemplary timing diagram for accessing and programming the multiple memory components of the system shown in FIG. 1, according to an embodiment of the present invention; and

FIG. 5 shows an exemplary block diagram of a multiple memory block disable circuit and its relation to a processor and its bus architecture, according to an embodiment of the present invention.

### DESCRIPTION OF THE SPECIFIC EMBODIMENTS

The present invention comprises a method and apparatus that provides a multiple memory block disable function.

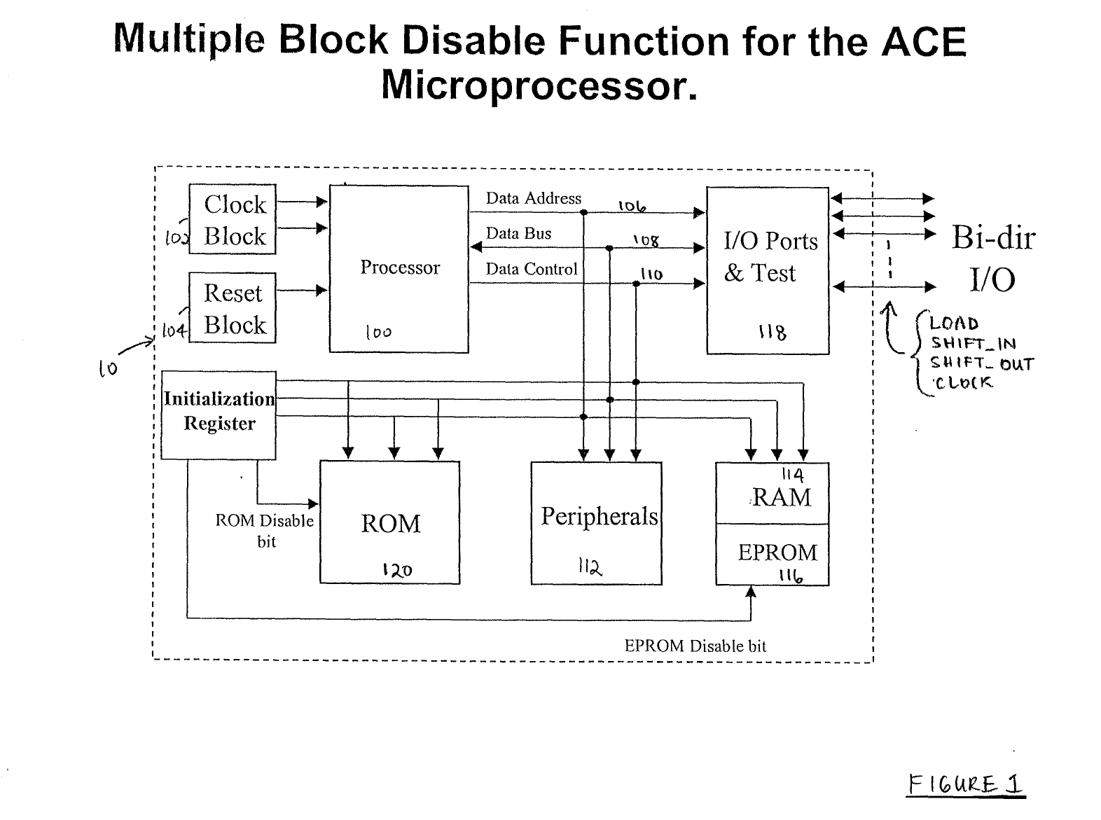

Referring to FIG. 1, there is shown a microcontroller system 10, which provides a multiple memory block disable function according to an embodiment of the present invention. Processor 100 is clocked by a system clock provided by clock block 102. A reset block 104 may also be provided to reset the microcontroller, for example, which may be necessary upon system power-up. Processor 100 communicates with other elements of system 10 via parallel signal lines, which taken together constitute the internal system bus. In FIG. 1, the system bus is shown as comprising three separate buses: an address bus 106, a data bus 108 and a control bus 110. The signal lines making up the system bus serve to connect processor 100 to other elements for the purpose of transferring data into and out of processor 100 (e.g. peripherals 112, random access memory (RAM) 114 and an erasable read only memory (EPROM) 116) and into and out of system 10 via input/output port 118. The signal lines also connect to a read only memory (ROM) 120, which stores microcode for directing the operation of processor 100.

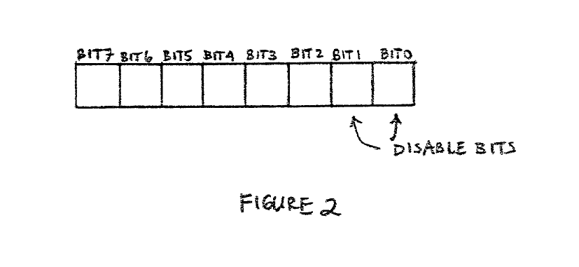

In the exemplary embodiment shown in FIG. 1, an initialization register 122 is included within system 10. FIG. 2 shows an exemplary embodiment of initialization register 122 comprising 8 bits. While 8 bits are used in this exemplary embodiment, other sized registers can also be used. Initialization register 122 is addressed in memory space on power-up and, among other things, initializes certain on-chip peripherals of system 10. The two least significant bits, bit 1 and bit 0, control the read/write access to ROM 120 and EPROM 116 of system 10. If bit 1 is set, attempts to read or write to any contents of EPROM 116 are disallowed. If bit 0 is set, attempts to read or write to any contents to ROM 120 are disallowed.

Programming ROM 120, EPROM 116 and initialization register 122 is accomplished via input/output port 118. In an exemplary embodiment, a four wire interface consisting of a LOAD control pin, a serial SHIFT_IN input pin, a serial SHIFT_OUT output pin and a CLOCK pin is used to access the various memory locations of system 10.

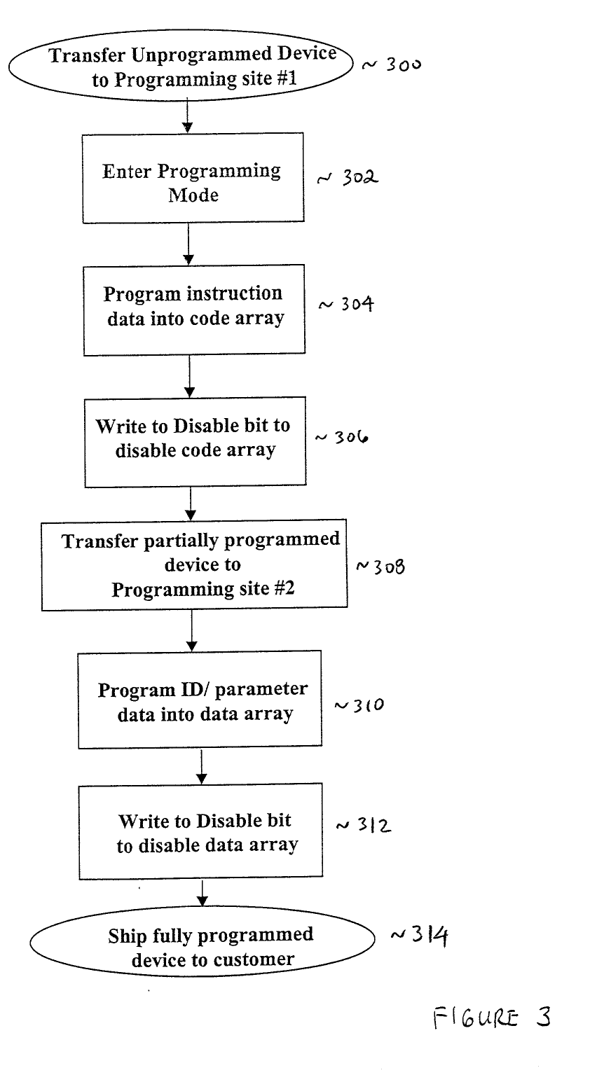

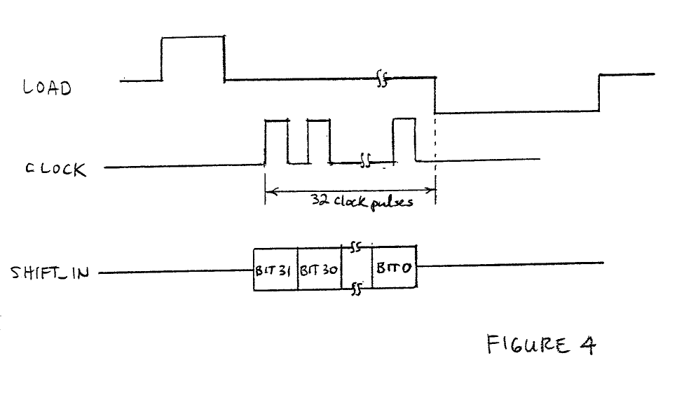

Referring now to FIG. 3, there is shown a flow chart, illustrating an exemplary method of programming ROM 120 and EPROM 116 of system 10 in FIG. 1, according to an embodiment of the present invention. At first step 300, an unprogrammed system 10 is delivered to a first programming site. At step 302, an external programmer brings system 10 into a programming mode by, for example, applying a supervoltage level to the LOAD pin of input/output port 118. Once programming mode is entered into, the programmer lowers the voltage applied to the LOAD pin to a nominal operating voltage (e.g. 5 volts). At step 304, the programmer shifts a serial command/data word (e.g., a 32-bit word) into ROM 120, via input/output interface 118. The SHIFT_IN and CLOCK signals are used to shift the data in as, for example, shown in the exemplary timing diagram in FIG. 4.

In this exemplary embodiment, bit 31 of the command/data word is shifted into system 10 first. The address of ROM 120, to which data is to be programmed, may be contained in bits 17-8 and the data to be programmed (e.g. a customer's program instruction data) may be contained in bits 7-0. Following programming, at step 306 the programmer sets a read/write disable bit (e.g. bit 0 in FIG. 2) to disable further attempts to read or write to ROM 120. The ROM disable bit may be, for example one of the two least significant bits of the command/data word, which has been shifted into initialization register 122 shown in FIG. 2, according to a predetermined address according to the memory space of the system.

Once the ROM 120 has been programmed and the disable bit is set to prevent further access to ROM 120, at step 308 the partially programmed system 10 is transferred to a second programming site. Then, at step 310, embedded EPROM 116 is accessed similar to the accessing and programming of ROM 120, which was done at the first programming site, and then programmed with, for example, parameter and serialization data. Once EPROM 116 is programmed, at step 312 the programmer at the second site sets a read/write disable bit to disable further attempts to read or write to EPROM 116. Finally, at step 314 the fully programmed device is sent to the customer.

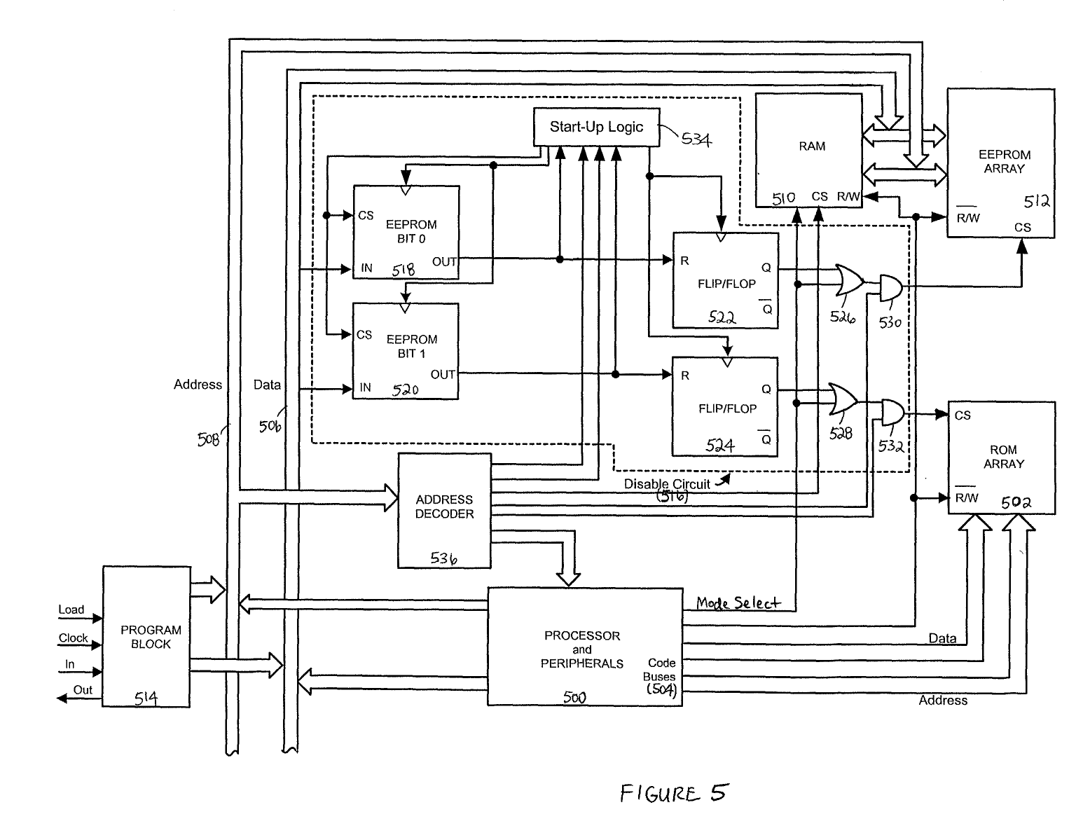

Referring now to FIG. 5, there is shown an exemplary block diagram of a multiple memory block disable circuit and its relation to a processor and its bus architecture, according to another embodiment of the present invention. The block diagram includes a processor 500 (the block within which processor peripherals are included for diagrammatic clarity), which is coupled to a ROM array 502 via code buses 504. Processor 500 communicates with other components in the block diagram, for example with RAM 510 and EEPROM array 512, via data bus 506 and address bus 508.

Processor 500 has two basic modes: Normal and Program. When power is applied to the system, processor 500 assumes Normal mode and takes control of the peripherals, including the memory arrays, and begins executing the code programmed. To enter Program mode to program ROM array 502, a user applies a voltage indicative of programming (e.g. 12 V) to a LOAD pin of a Program Block 514. When the LOAD pin is asserted for Program mode, data and address information can be moved into and out of Program Block 514, for example, by a 32-bit shift register included within Program Block 514.

The block diagram in FIG. 5 includes a disable circuit 516, which comprises a first and second EEPROM bits 518, 520 (bit 0, bit 1), first and second flip-flops 522 and 524, OR logic gates 526 and 528, AND logic gates 530 and 532, and Start-Up logic 534. An address decoder 536 provides addressing information to Start-Up logic 534 and processor 500 from addresses presented on address bus 508.

If a user wishes to program either ROM array 502 or EEPROM array 512, a program pulse (e.g. 12 V) is applied to the LOAD pin of Program Block 514, which then puts the system into Program mode. In Program mode, the user is able to read and/or write data to ROM array 502 and EEPROM array 512. However, this read and/or write access is disabled, in whole or in part, if either or both the ROM array 502 and EEPROM array 512 are disabled by the disable circuit 516, which is outlined by the dashed line in FIG. 5.

ROM array 502 may be disabled by disable circuit 516 by first providing a programming pulse (e.g. 12 volts) to the LOAD input of Program Block 514 to put the system in Program mode. During Program mode, the Mode select output of processor 500 is set to a logical 0. In Program Mode, a user shifts in, for example, a 32-bit frame so that second EEPROM bit 520 is set to a logical 1. This logical 1 is clocked into second EEPROM bit 520 and then clocked into second flip-flop 524, which resets the Q output of second flip-flop 524 to a logical 0. Accordingly, because both inputs to OR gate 528 are at a logical 0, the output of OR gate 528 and, consequently, the output of AND gate 532 are set to a logical 0. A logical 0 at the output of AND gate 532 is applied to the CS input of ROM 502 so that read and/or write access to ROM 502 is disabled.

The procedure and circuitry used to disable EEPROM array 512, after it is programmed, is similar to that described above for ROM array 502. Preferably the disabling of EEPROM array 512 is performed after ROM 502 is programmed, disabled and transferred to a second programming site, as was described above. EEPROM array 512 may be disabled by disable circuit 516 by first providing a programming pulse (e.g. 12 volts) to the LOAD input of Program Block 514 to put the system in Program mode. During Program mode, the Mode select output of processor 500 is set to a logical 0. In Program Mode, a user shifts in, for example, a 32-bit frame so that first EEPROM bit 518 is set to a logical 1. This logical 1 is clocked into first EEPROM bit 518 and then clocked into first flip-flop 522, which resets the Q output of second flip-flop 522 to a logical 0. Accordingly, because both inputs to OR gate 526 are at a logical 0, the output of OR gate 526 and, consequently, the output of AND gate 530 are set to a logical 0. A logical 0 at the output of AND gate 530 is applied to the CS input of EEPROM 512 so that read or write access to EEPROM 512 is disabled.

After each disable bit of ROM array 502 and EEPROM array 512 is set, the system is powered down and then powered up again by Start-Up logic 534. The purpose of Start-Up logic 534 is to sense and monitor when the system is powered and cause the transfer of the logical value (i.e. 0 or 1) stored in first and second EEPROM bits 518 and 520 to be loaded into corresponding first and second flip-flops 522 and 524. However, this loading is allowed to occur if and only if the disable bits are not set. In other words, if any one of the bits of the first and second EEPROM bits 518 and 520 are set to 1, the Start-Up logic 534 will not load the flip-flops and will not allow the EEPROM bit values of EEPROM bits 518 and 520 to ever change.

Although the invention has been described in terms of a preferred methods and structure, it will be obvious to those skilled in the art that many modifications and alterations may be made to the disclosed embodiments without departing from the invention. For example, while memories 116 and 120 in FIG. 1 are shown to be a ROM and EPROM, respectively, other types of memory, either volatile or non-volatile may also be used with minor modifications to the circuitry. Also, while memories 116 and 120 are shown to be separate memory components, each of these components could be combined in a single block of memory so that the disable bits can disable select sub-blocks of the block similar to the scheme describe above. Further, while two memory disable bits are used in the exemplary embodiments, the number of memory disable bits to disable these and other memory components of a system are within the conceived scope of the present invention. Additionally, the number, order and specification of bits of the command/word described in relation to FIGS. 1, 2 and 5 is merely exemplary and other numbers, orderings and specifications can be used. And, while the address of data to be programmed was describes as being contained within each command/word, the address may be separate from the command/data word and so that it can be applied to the address decoder directly over, for example, the address bus. For the foregoing reasons, therefore, these and other modifications and alterations are intended to be considered as within the spirit and scope of the invention as defined by the appended claims.

What is claimed is:

1. A method of disabling multiple memory blocks in a microcontroller system, comprising the steps of:
programming a first set of data into a first memory block;
disabling read and write access to the programmed first memory block;
programming a second set of data into a second memory block; and
disabling read and write access to the second memory block.

2. The method of claim 1, wherein the first set of data comprises software for directing operation of the system.

3. The method of claim 1, wherein the first memory block comprises a non-volatile memory.

4. The method of claim 1, wherein the second memory block comprises an erasable programmable read only memory (EPROM).

5. The method of claim 1, wherein the second set of data comprises a password that enables operation of the system.

6. A microcontroller system, comprising:
a processor
a first memory block in communication with the processor;
a second memory block in communication with the processor; and
a register in communication with the first and second memory blocks, the register having two or more disable bits that control a read or write access to the first and second memory blocks.

7. The system of claim 6, wherein the first memory block is configured to store software for directing operation of the system.

8. The system of claim 6, wherein the first memory block comprises a non-volatile memory.

9. The system of claim 6, wherein the second memory block comprises an erasable programmable read only memory (EPROM).

10. The system of claim 6, wherein the second memory block is configured to accept a customer password to enable operation of the system.

11. A microcontroller system, comprising:
a processor;
a first memory block in communication with the processor;
a second memory block in communication with the processor; and
a disable circuit, in communication with the processor, operable to disable the first memory block following a first programming operation and disable the second memory block following a second programming operation.

12. The system of claim 11 wherein the first memory block is read only memory.

13. The system of claim 11 wherein the second memory block is electrically erasable programmable read only memory.

14. The system of claim 11 wherein the first memory block is configured to store software for directing operation of the system.

15. The system of claim 11 wherein the second memory block is configured to store application specific software.
